(19) United States
(12) Patent Application Publication
(10) Pub. No.: US 2011/0089239 A1
(43) Pub. Date: Apr. 21, 2011

(54) Radio Frequency Absorption

(75) Inventors: Greg Peter Wade Fixter, Hook (GB); Christopher Douglas James Spooner, Bracknell (GB)

(73) Assignee: QINETIQ LIMITED

(21) Appl. No.: 12/999,745

(22) PCT Filed: Jun. 17, 2009
(86) PCT No.: PCT/GB09/01509

§ 371 Date: Dec. 17, 2010

(30) Foreign Application Priority Data
Jun. 21, 2008 (GB) 0811493.6

(51) Int. Cl. G06K 7/12; G06K 7/10; H01Q 17/00

(52) U.S. Cl. 235/439; 342/1

(57) ABSTRACT

Apparatus for interrogating a defined read space, including RFID reader antenna (408, 410) and at least one absorber panel (402, 404) arranged about said read space, and including an array of circuit analogue (CA) elements. Such apparatus is particularly useful in situations in which multiple readers are arranged in proximity, sometimes referred to as dense reader mode (DRM). The absorber can be tuned to a particular desired frequency, and can be less than a quarter of a wavelength of that desired frequency in thickness.

This invention relates to absorption of radio frequency (RF) energy, and particularly but not exclusively to RF absorbers in portal applications.

Radio frequency identification (RFID) is becoming increasingly common in logistics applications such as asset tracking in storage and distribution facilities. Commonly an RFID tag is attached to items or batches of items, and the tags can be interrogated by a reader to determine information concerning the tagged item or items. The amount of information which can be associated with an item depends on the complexity of particular system being employed. A basic system could simply provide a serial number or electronic product code (EPC), while a more advanced system could provide information on ambient conditions of the item eg temperature or humidity.

Typically a reader comprises an antenna which emits radiation at a standard frequency, and a tag comprises a passive transponder which is driven into operation by incident radiation at the standard frequency, and produces a response which is detected by the reader. Read ranges of up to 5 m are not uncommon for such a passive arrangement. A wide variety of different types of RFID systems are well known however (eg active tags having a dedicated power source) and are employed in logistics applications with varying degrees of sophistication.

One advantage of RFID is the ability to read more than one tag at a time. Thus a pallet of items can be interrogated and each item on the pallet can provide a response substantially simultaneously. A common scenario is therefore to arrange a reader in a portal configuration, to interrogate items passing through a gate or doorway, either singularly or in batches, to monitor and control the flow of items in a distribution warehouse for example.

A situation in which multiple readers are arranged in proximity is sometimes referred to as dense reader mode (DRM). In such a situation care must be taken to ensure that tags do not provide false indications to multiple readers within range. For example items passing through a gate should not register with a reader at an adjacent gate. Various types of screens have previously been proposed to shield or isolate readers, however such prior art screens suffer a number of disadvantages. Metallic screens suffer from stray reflections for example, while loaded rubber screens tend to be bulky and expensive.

It is an object of the present invention to overcome or ameliorate certain problems associated with prior art reader apparatus and absorber panels.

According to a first aspect of the present invention then, there is provided apparatus for interrogating a defined read space, including an RFID reader antenna and at least one absorber panel arranged about said read space, and adapted to isolate said read space at least partially by absorption of incident RF energy, wherein said absorber panel includes an array of circuit analogue elements.

Circuit analogue (CA) layers refer to geometrical patterns which are made up of conducting material. They are often defined by their effective conductance and susceptance, which together can be used to model the electromagnetic response of the layer. In this specification therefore, the term circuit analogue element is used to refer to a conducting pattern, the precise geometry and material conductivity of which allows the absorption of a CA-structure (comprising the CA element) to be tuned to a designed frequency. Such elements have previously been proposed for applications such as anechoic chambers and stealth coatings, and are typically designed to absorb radiation in a wide range of frequencies. Here however, since a reader antenna is emitting radiation at a known frequency, the absorber panel can advantageously be tuned to provide a desired level of attenuation at that particular frequency.

The RFID reader antenna emits radiation at a centre frequency having wavelength λ. It will be understood by the skilled reader that the reader antenna will in reality emit energy in a range of frequencies, however the frequency at the centre of this range, or the nominal operational frequency will commonly be referred to.

Preferably the absorber provides attenuation of greater than or equal to 20 dB at the centre frequency. Since the absorber is tuned to this centre frequency, attenuation drops off at away from this frequency, however to allow for manufacturing tolerances and other practical considerations, and attenuation of greater than or equal to 20 dB is typically provided in a bandwidth of approximately 100 MHz centred about the nominal. Typically beyond 50 MHz either side of the centre frequency attenuation falls below 20 dB, and may be 10 dB or less. In this way, other systems in the vicinity of the portal which operate a different frequencies remain substantially unaffected.

Where the RFID reader antenna emits radiation at a nominal frequency, the real component of the admittance resonance of the absorber panel is preferably tuned to be substantially 1 at the nominal frequency of operation. This results in maximum absorption of energy at that frequency. The imaginary component of the admittance resonance is preferably maximised at the nominal frequency in order to allow reduced thickness of the panel, and is preferably greater than or equal to 1. Embodiments of the invention provide absorber panels of thickness less than or equal to λ/4, where λ is the wavelength of radiation at the nominal frequency. In certain embodiments, thicknesses of λ/6, λ/10 or less are possible.

In a preferred embodiment the circuit analogue elements form an array of ring elements, and each element preferably comprises four straight tracks arranged to form a rectangle or square. Although other track arrangements are possible (eg circles, crosses etc) squares have been shown to provide a good attenuation stability over a range of angles of incidence.

A surface resistance of approximately 700 Ω/sq has been found to be advantageous for the circuit analogue elements, and preferably the variation in surface resistance across all elements of the array is less than +/−10%.

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

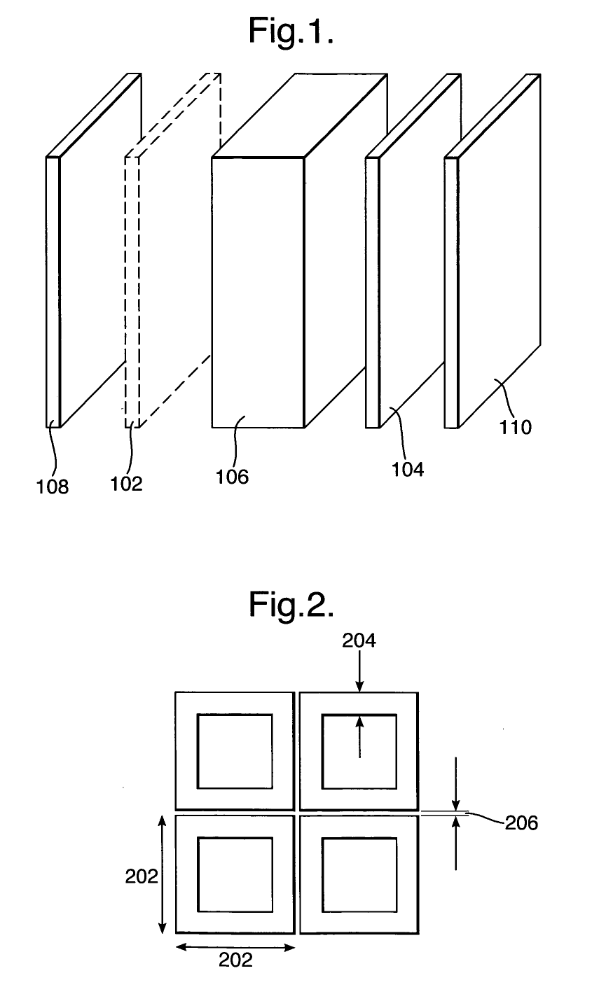

FIG. 1 illustrates a cross section through an absorber panel according to aspects of the present invention.

FIG. 2 shows a preferred layout for the circuit analogue elements.

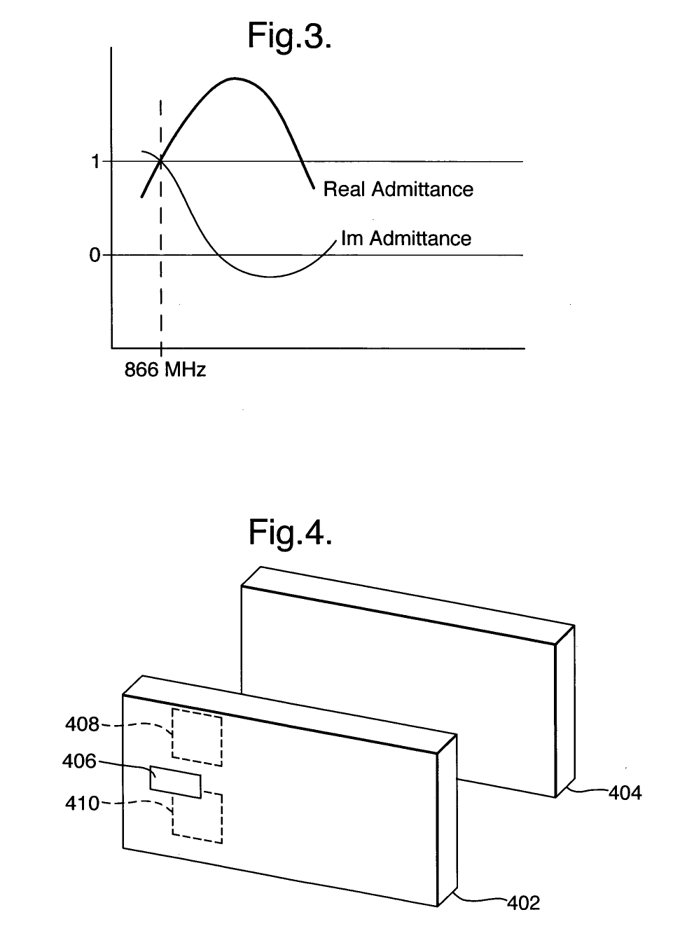

FIG. 3 is a plot of real and imaginary admittance for the circuit analogue elements shown in FIG. 2.

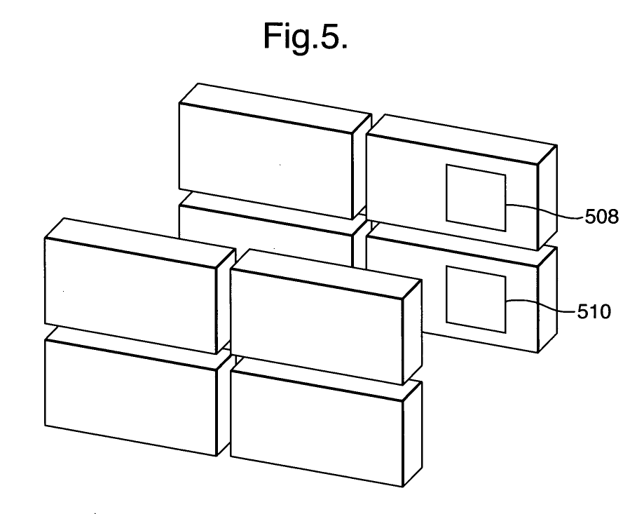

FIGS. 4 and 5 show RFID portals according to embodiments of the invention

Referring to FIG. 1, the functional core of the absorber is formed of a frequency selective circuit analogue layer 102 and a metallic foil or backplane 104, separated by a dielectric spacer layer 106. The spacer layer may be a plastic honeycomb structure, or a foam for example. Such layers are typically bonded together with adhesive. Optionally an outer skin 108, 110 is provided to enclose and protect the panel. In this example a formica skin is bonded to the front and back surfaces of the functional core, but other materials such as glass reinforced plastic are equally possible. The edges of the panel are typically capped with a plastic extrusion to seal the panel environmentally.

Foam spacer layer 106 is 40 mm thick in this example, intended for operation at 866 MHz interrogation frequency. The outer skin is of the order of 1 mm in thickness, and thus the complete package is less than 45 mm thick, in comparison to the operational wavelength of approx 350 mm. The mass per unit area of the illustrated embodiment is approximately 10 kg/m².

FIG. 2 illustrates the geometry of the circuit analogue elements for a preferred embodiment. It can be seen that the elements are square, with external side dimensions 202 of 30 mm, and track width 204 of approximately 6 mm. The elements are arranged with a gap 206 of approximately 1 mm, such that the array spacing is 31 mm centres. The elements themselves are formed of a resistive carbon compound having a surface resistance of approximately 700 Ω/sq on a polyester substrate, to produce the layer 102 for inclusion in the absorber panel.

The geometry and resistance of the elements are chosen to tune the admittance resonance of layer 102 so that the real component is substantially 1 (for maximum absorption) and to maximise the imaginary component (to promote low thickness) at the frequency of operation, here 866 MHz.

The real and imaginary admittance for the illustrated circuit analogue design are illustrated in FIG. 3. Here the layer is tuned to operate as 866 MHz however layers can be tuned to other frequencies (eg 915 MHz in US) by varying the geometry and resistance of the individual elements. It can be seen in this example that both real and imaginary components of the admittance resonance are substantially equal to 1.

Turning to FIG. 4, there is illustrated schematically an RFID portal according to an aspect of the present invention. Two absorber panels 402 and 404 are mounted opposite one another to define a portal therebetween. Mounted on the exterior surface of panel 402 is a reader unit 406 , connected to two antenna units 408, 410 (shown dashed line) mounted on the interior surface. Typically a separate emitter antenna and a reader antenna are used, although a single antenna can be used to provide both functions. Alternatively the antenna units could be embedded into the panel and provided with a lens cover. In a single portal, panel 404 need not include any reader apparatus, however if panel 404 is configured in the same way as panel 402, an adjacent portal can be formed. This can be extended similarly to form multiple adjacent portals. Each absorber panel will be of the order of 2 m×2 m in these configurations.

FIG. 5 shows a variation in which a number of smaller, modular panels are employed to ease transportation. Such panels require local assembly, using for example conducting seal or tape to form panel joints. Here antenna units 508, 510 are shown mounted on the far panel as viewed. The reader unit is not shown.

It will be understood that the present invention has been described above purely by way of example, and modification of detail can be made within the scope of the invention.

Each feature disclosed in the description, and (where appropriate) the claims and drawings may be provided independently or in any appropriate combination.

1. Apparatus for interrogating a defined read space, including an RFID reader antenna and at least one absorber panel arranged about said read space, and adapted to isolate said read space at least partially by absorption of incident RF energy, wherein said absorber panel includes an array of circuit analogue elements.

2. Apparatus according to claim 1, wherein the RFID reader antenna emits radiation at a centre frequency having wavelength λ, and the thickness of the absorber panel is less than λ/4.

3. Apparatus according to claim 1, wherein the absorber provides greater than or equal to 20 dB attenuation in a frequency band of 100 MHz about said centre frequency.

4. Apparatus according to claim 1, wherein the RFID reader antenna emits radiation at a centre frequency, and wherein the real component of the admittance resonance of the absorber panel is substantially 1 at the centre frequency.

5. Apparatus according to claim 1, wherein the RFID reader antenna emits radiation at a centre frequency and wherein the imaginary component of the admittance resonance is greater than or equal to 1 at the centre frequency.

6. Apparatus according to claim 1, wherein said circuit analogue elements are square

7. Apparatus according to claim 1, wherein said circuit analogue elements are formed of a resistive compound having a surface resistance of substantially 70 Ω/sq.

8. Apparatus according to claim 1, wherein the variation in surface resistance across all elements of the array is less than +/−10%.

9. Apparatus according to claim 1, wherein the mass per unit area of the absorber panel is less than or equal to 20 kg/m².

10. Apparatus according to claim 1, wherein said RFID reader antenna is embedded within said at least one panel.

11. An absorber panel for an RFID portal adapted to absorb radiation at an operating frequency, said panel including an array of circuit analogue elements, wherein the thickness of said panel is less than λ/4, where λ is the wavelength of radiation at said operating frequency.

12. An absorber panel according to claim 11, wherein said panel provides greater than or equal to 20 dB attenuation in a 100 MHz frequency band centred about said operating frequency.

13. An absorber panel according to claim 11, wherein said circuit analogue elements are square and formed of a resistive compound such that the real component of the admittance resonance of the absorber panel is substantially 1, and the imaginary component of the admittance resonance is greater than or equal to 1, at said operating frequency.

14. An absorber panel according to claim 11, wherein said circuit analogue elements have a surface resistance of substantially 70 Ω/sq. and wherein the variation in surface resistance across all elements of the array is less than +/−10%.
